(19) United States
(12) Patent Application Publication
(10) Pub. No.: US 2007/0277098 A1
(43) Pub. Date: Nov. 29, 2007

(54) Method and System for Presentation of Information Postings to Prompt Reflection

(76) Inventors: Elad Shahar, Haifa (IL); Michal Jacovi, Rakefet (IL)

Correspondence Address: IBM CORPORATION, T.J. WATSON RESEARCH CENTER, P.O. BOX 218, YORKTOWN HEIGHTS, NY, 10598, US

(21) Appl. No.: 11/420,493

(22) Filed: May 26, 2006

(51) Int. Cl. G06F 15/00

(52) U.S. Cl. 715/526

(57) ABSTRACT

A method and system for presenting information are provided in which multiple information postings (231, 232, 233) on a user accessible display (206) are generated by one or more users. The user accessible display (206) is updated to show most recently input information postings. A sub-display (210) of a reference to or contents of a previous information posting (211) is provided with a link (212) to the previous information posting. The sub-display (210) has the purpose of prompting a user to reflect on the previous information posting (211). The selection of the previous information posting for the sub-display (210) is by an algorithm (223) based on heuristics applied to previous information postings (231, 232, 233).

### FIELD OF THE INVENTION

This invention relates to the field of presentation of information postings. In particular, the invention relates to presentation of information postings on a user accessible display to prompt reflection by a user.

### BACKGROUND OF THE INVENTION

Reflection is focused, rational thought which is triggered by some surprise, problem or difficulty, and is aimed at uncovering something that is hidden. The process of reflection suspends the automatic actions and associative thoughts which rapidly follow each other in the usual process of being. Reflection helps us organize our thoughts, determine relationships between the objects of reflection, and understand them. Reflection helps to convert blind and impulsive action into planned, intelligent action, which better serves the actor's goals. According to several models of learning, some forms of learning require reflection for learning to occur. For example, in a known model of experiential learning, four stages form a cycle where each stage leads to another. It is the stage of observation and reflection which enables people to form abstract concepts from concrete experience.

Journal writing reveals one's own thought processes and habits, aids memory, and provides a context for personal growth. Journal writing has been used extensively for education, for professional development, and in the work place. Journal writing helps people to become more reflective. Writing involves a cyclical pattern of reflection: first, reflecting on experiences as you write; and then reflecting on the journal entries themselves at some later stage, which may provide material for further reflection, and so on.

There are currently many different systems including information presentation in which one or more users can post a journal entry or other information which is displayed either privately to the individual user or shared by users. The information postings are often displayed in reverse chronological order with the most recently posted items in the foremost display. Examples, of such systems including information presentation with user generated postings include:
Web logs (“blogs”) which are web-based personal journals which are typically owned by one author who composes the postings, but readers may add “talkbacks”. A talkback is a user's comment to a posting in a blog and allows readers to talk back to the author, fostering discussion between author and readers.
Web forums in which multiple users contribute to a discussion.
Open content Web sites allowing user input, for example WIKI Web sites such as Wikipedia (Wikipedia is a trade mark of Wikimedia Foundation, Inc.).
Personal electronic journals.
Personal workspaces in which daily information is organized.
Shared or collaborative workspaces.
Email messaging.
Any other system in which one or more users posts user authored information.

It is especially beneficial to encourage reflection on past information postings when the user or users have common specific goals—that they want to achieve something or learn something. In order to achieve these goals, the users are engaged in action, and use the system to write about their activity, personal involvement, and personal experiences. In such contexts, past postings have greater chances of being relevant and interesting, and reflecting about them may provide greater assistance in advancing these goals.

Reflection involves reference to one's past. Past experience provides a basis for suggestions to overcome the difficulties that initiated reflection in the first place. Examination of the past can also help to evaluate these suggestions by comparing the present situation or problem with similar cases in the past. Furthermore, reaching conclusions requires organizing knowledge by reviewing facts and ideas which have been observed and raised in the past, and relating them to each other.

Although journals are widely acknowledged for encouraging reflection, they are most effective in the context of courses, where assignments, questions, and habits can be enforced by the instructor.

For example, many courses have used journals to force reflection, by asking explicit questions which the student must answer. This can work in a course where the students are obliged to their instructor's orders, yet it does not integrate naturally into one's daily habits. The additional work of answering questions daily, or weekly, without an internal need, may cause individuals to not perceive the direct benefit of this extra work. Furthermore, obtrusively querying the user is disruptive to the more frequent work of posting and reading postings.

Although not specifically aimed at aiding reflection, there are several applications which aid memory in general.

Search and information retrieval applications aid one's direct-recall memory, where the searcher is actively trying to find information.

Remembrance Agents (RAs) are continuously running automated information retrieval applications which continuously observe a user's environment and provide information relevant to the user and their current situation. Suggested documents are displayed in a buffer at the bottom of the user's display, and are updated every few seconds based on the last hundred or so words surrounding the cursor. In contrast to search applications, remembrance agents provide information without prompting by the user.

However, the memory aids above address a different problem: helping the user accomplish whatever task they are currently working on. Encouraging reflection may require the opposite: to evoke a response which may cause the user to break away from what they are currently working on, and engage in deeper thought on a broader context.

It is an aim of the proposed system and method to encourage reflection in contexts which are not highly structured, where no instructor may be available.

### SUMMARY OF THE INVENTION

According to a first aspect of the present invention there is provided a method for presenting information, comprising: inputting multiple information postings on a user accessible display, said information postings being generated by one or more users; updating the user accessible display to show most recently input information postings; generating a sub-display of a reference to or contents of a previous information posting with a link to the previous information posting; wherein the sub-display has the purpose of prompting a user to reflect on the previous information posting.

According to a second aspect of the present invention there is provided a system for presenting information comprising: means for inputting multiple information postings on a user accessible display, said information postings being generated by one or more users; means for updating the user accessible display to show most recently input information postings; means for generating a sub-display of a reference to or contents of a previous information posting with a link to the previous information posting; wherein the sub-display has the purpose of prompting a user to reflect on the previous information posting.

According to a third aspect of the present invention there is provided a computer program product stored on a computer readable storage medium, comprising computer readable program code means for performing the steps of: inputting multiple information postings on a user accessible display, said information postings being generated by one or more users; updating the user accessible display to show most recently input information postings; generating a sub-display of a reference to or contents of a previous information posting with a link to the previous information posting; wherein the sub-display has the purpose of prompting a user to reflect on the previous information posting.

According to a fourth aspect of the present invention there is provided a method of providing a service to a customer over a network, the service comprising: generating a sub-display of a reference to or contents of a previous information posting with a link to the previous information posting; wherein multiple information postings on a user accessible display are generated by one or more users, and wherein the sub-display has the purpose of prompting a user to reflect on the previous information posting.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a known computer system in which the present invention may be implemented;

FIG. 2 is a block diagram of a system in accordance with the present invention;

FIG. 3 is a flow diagram of a method in accordance with the present invention;

FIG. 4A is a user interface as known in the prior art showing a web log; and

FIG. 4B is an embodiment of a user interface in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

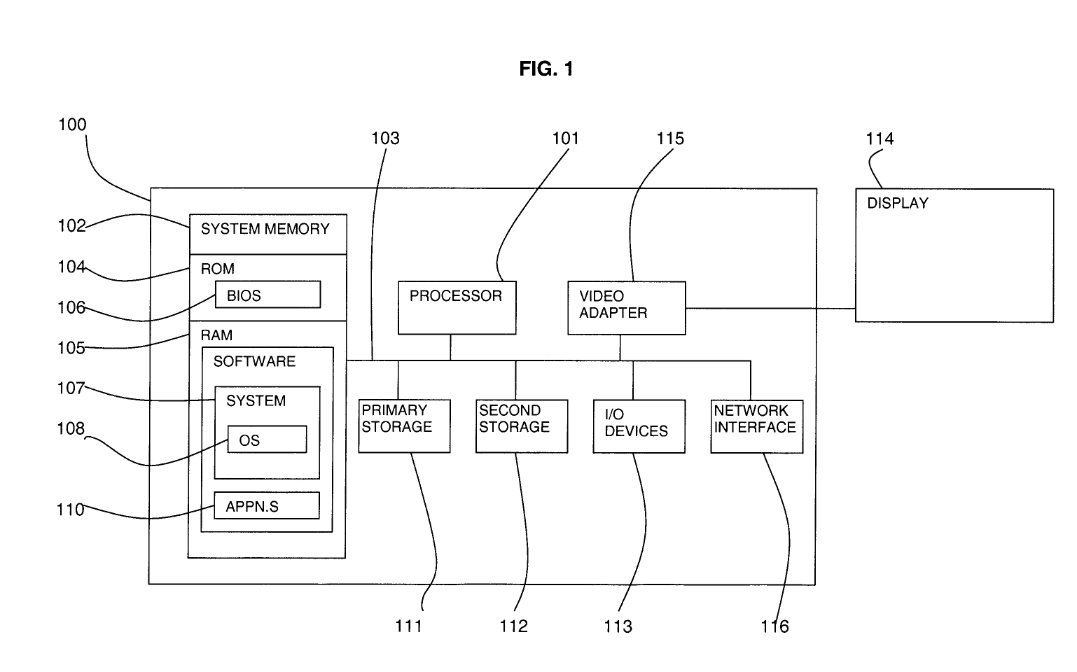

Referring to FIG. 1, an exemplary system for implementing the invention includes a data processing system 100 suitable for storing and/or executing program code including at least one processor 101 coupled directly or indirectly to memory elements through a bus system 103. The memory elements can include local memory employed during actual execution of the program code, bulk storage, and cache memories which provide temporary storage of at least some program code in order to reduce the number of times code must be retrieved from bulk storage during execution.

The memory elements may include system memory 102 in the form of read only memory (ROM) 104 and random access memory (RAM) 105. A basic input/output system (BIOS) 106 may be stored in ROM 104. System software 107 may be stored in RAM 105 including operating system software 108. Software applications 110 may also be stored in RAM 105.

The system 100 may also include a primary storage means 111 such as a magnetic hard disk drive and secondary storage means 112 such as a magnetic disc drive and an optical disc drive. The drives and their associated computer-readable media provide non-volatile storage of computer-executable instructions, data structures, program modules and other data for the system 100. Software applications may be stored on the primary and secondary storage means 111, 112 as well as the system memory 102.

The data processing system 100 may operate in a networked environment using logical connections to one or more remote computers via a network adapter 116.

Input/output devices 113 can be coupled to the system either directly or through intervening I/O controllers. A user may enter commands and information into the system 100 through input devices such as a keyboard, pointing device, or other input devices (for example, microphone, joy stick, game pad, satellite dish, scanner, or the like). Output devices may include speakers, printers, etc. A display device 114 is also connected to system bus 103 via an interface, such as video adapter 115.

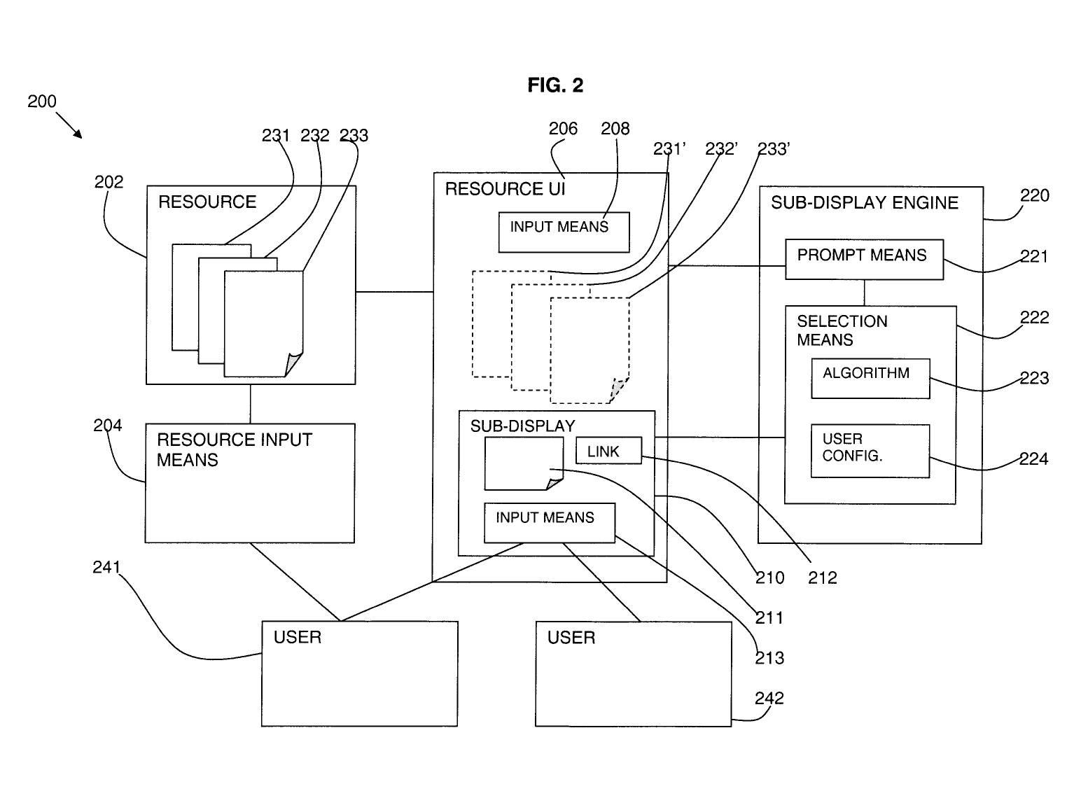

Referring to FIG. 2, a computer system 200 is shown which may be an independent personal computer system, a client system, or a server system in which a resource 202 is provided to which one or more users 241, 242 may add information postings 231, 232, 233. The resource 202 may be a privately owned resource on a personal computer system, a shared resource accessible by multiple users via a local or wide area network, or a publicly accessible resource such as web page.

A resource user interface 206 is provided for display of the information postings 231, 232, 233 of the resource 202. The display of the information postings on the resource user interface 206 is shown in hashed lines 231′, 232′, 233′. The resource user interface 206 is accessible to the one or more users 241, 242 of the system 200. A resource user interface 206 may provide access to pages of information, or multiple documents of information. An input by a user 241 may be added to the resource 202 and published to the resource user interface 206. The resource 202 may have a user input means 204 for users to input information into the resource 202 or this may be provided as part 208 of the resource user interface 206.

In one embodiment, the resource user interface 206 automatically shows the most recently input information postings 231, 232, 233 and when new information is input into the resource 202, the older information may be pushed to another page or document. Scrolling or forwarding through pages of the resource user interface 206 can retrieve older information postings. A resource user interface 206 may be provided by a local application on a user system and may be, for example, a web browser application.

The described system includes a sub-display 210 provided in the resource user interface 206 including a reference to or some or the whole contents of a previous information posting 211 in the resource 202. The sub-display 210 may provide a link 212 to the previous information posting 211. The sub-display 210 optionally includes input means 213 for a user to respond to the sub-display 210 information.

A sub-display engine 220 is provided including a prompt mechanism 221 for prompting a different previous information posting 211 to be displayed in the sub-display 210. The prompt mechanism 221 may be triggered by a user viewing a different information posting 231, 232, 233 on the resource user interface 206, by the user refreshing the resource user interface 206, or after a predetermined time period resulting in different previous information postings 211 being displayed to a user prompting reflection.

The sub-display engine 220 also includes a selection means 222 which selects a previous information posting 211 for display in the sub-display 210. The selection means 222 uses an algorithm 223 based on heuristics of the resource 202. The selection means 222 also includes user preference input means 224 for a user to set the parameters for the algorithm 223.

The various components of the resource 202, resource user interface 210, sub-display engine 220, etc. may be located across client and servers of a distributed computing system. For example, the resource 202 may be a web page located on a server and the sub-display engine 220 may be provided as an application on a client or another server.

The sub-display 210 is referred to as a “reflection panel” as it has the aim of prompting the one or more users to reflect on a previous information posting.

There are several benefits which may arise specifically from reflecting upon past information postings:
An unsolved issue in the past may be addressed in a new light, finding a solution as a result. A solved issue in the past may be offered an improved solution. A solved issue in the past may suggest a good solution to a current problem.
Being aware to what one has done in the past can bring about a sense of accomplishment (or lack thereof) of what has been achieved so far, and put the daily work in its temporal perspective. It can give a sense of whether one is “on-track” with respect to one's project goals, career goals, educational goals, etc.
Past suggestions and actions, successful or unsuccessful, viewed in hindsight, can trigger reflection about what worked and what did not work and why. Such analysis can be made in order to make things work better in the future, fostering personal growth.

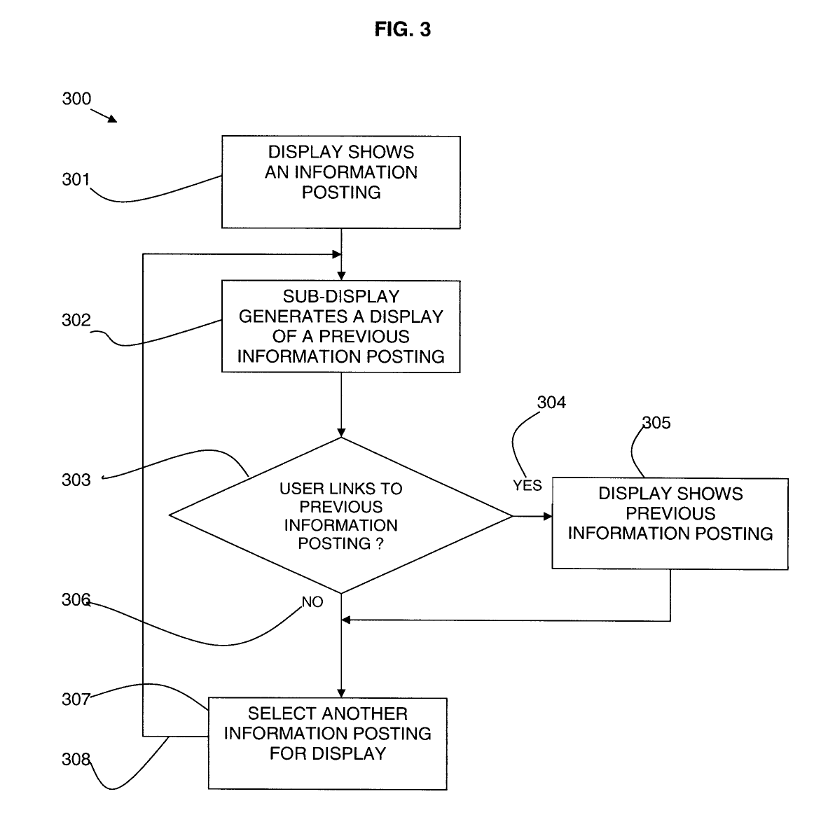

FIG. 3 shows a flow diagram 300 of an embodiment of the described method. The flow diagram 300 includes the steps of displaying 301 an information posting and generating 302 a sub-display with a reference to a previous information posting. The previous information posting of the sub-display is determined by an algorithm based on heuristics applied to previous information postings and prompts reflection.

A user may choose the link to the previous information posting referenced in the sub-display 303. If the user does choose the link 304 to the previous information posting, the display shows 305 the previous information posting.

If the user does not choose the link 306 to the previous information posting, or the user has viewed the previous information posting 305 and wishes to continue by viewing another information posting, another information posting is selected 307 for display. The method then loops 308 and the sub-display generates 302 another previous information posting.

The time of generation of a new previous information posting in the sub-display may be configured by a user. It may be configured to change after a predetermined time, when a user refreshes the display, or as prompted by a user.

The algorithm for selecting postings for the reflection panel is now described. The goal of the algorithm is to randomly draw a posting that has high chances of igniting a reflection process. A set of heuristics is proposed that assign values to all postings. Some of the values are calculated in advance, while others depend on the user context and are calculated on the fly. When the reflection panel is launched or refreshed, the assigned (and on-the-fly-calculated) values are used in order to draw a single posting to be presented. The heuristics are based on different criteria such as temporal, textual, and contextual, and they are configurable and take user preferences into account.

Below the proposed heuristics are listed and the values they assign. Different heuristics may be easily added. The heuristics are weighted, so their contribution to the overall probability of the posting depends on their relative weight.

For each posting Pᵢ, and for each heuristic Hⱼ, a value Vᵢⱼ(0≦Vᵢⱼ<1) is calculated that represents the value Hⱼ assigns to Pᵢ.

Each heuristic Hⱼ has a weight Wⱼ that represents its influence on the overall probability.

For each posting Pᵢ its assigned value is calculated:

$${V}_{i} = {\sum }_{j} {W}_{j} {V}_{ij}$$

Finally, the values are normalized and the probability P(Pᵢ) of each posting calculated:

$$P ( {P}_{i} ) = {V}_{i} / {\sum }_{k} {V}_{k}$$

The probabilities P(Pᵢ) are then used in order to draw a posting to be presented in the reflection panel.

### Temporal Heuristic

Some learning takes time, and requires the ability to view particular events in a wider context. Therefore, it may be advantageous to suppress the appearance of postings from the recent past in the reflection panel, since not enough time has passed to process the event, and develop an ability to view the event in a wider context.

This heuristic defines three “temporal zones”:
Recent past.
Intermediate past.
Distant past.
   The actual definition of the zones is configurable. As an example, the default may be set to “less then one month ago”, “one month ago to six months ago”, and “more than six months ago” respectively.

The postings are assigned a value based on the zone their publication date belongs to. The values are configurable and will be set, by default, to 0.1, 0.6, and 0.3 respectively. The rationale behind these values is that recent postings are not likely to raise reflection and the benefit of reflection for them is not expected to be high; postings from the distant past may raise reflection, but are likely to be outdated; postings from the intermediate past are the most likely to ignite fruitful reflection. The user may configure these values, according to posting and reflection habits.

The values assigned by this heuristic may be calculated in advance, but require occasional re-calculation (e.g., overnight) as the time goes by.

### Temporal Patterns Heuristic

If a person encounters a situation now that he has already encountered in the past, recalling his behavior and feelings then could be enlightening. One might have behaved better in the past, yet not recall it. Or one could have behaved miserably in the past, and consider how to change the situation for a similar impending event. Finally, one could compare a previous periodic event to a current one, and learn about any change or progress.

The reflection panel can encourage a user to reflect on past user postings taking into consideration the user's temporal patterns of behaviour. Temporal patterns assume that certain events occur periodically, and recalling past events while similar current events occur may result in fruitful reflection. This heuristic assigns higher values to postings that were posted according to some temporal pattern.

Examples are:
Postings that were posted in proximity to repeating events (yearly evaluation of Personal Business Commitments, exam period, tax report time; as well as approaching holiday or birthday) that is expected to occur soon.
By default these will be assigned the value 1. The user may configure the details of this heuristic by updating/reviewing a calendar of events.
There may be numerous repeating events that are not in a calendar, and the user would not bother entering all of them in the settings for the reflection panel. It may not be possible to tell exactly what happens when, but a heuristic for finding such periodic events would be to look back according to standard time units, such as a year, or month.
So we consider postings there were published exactly one month/year ago.
Default value to such postings will be 1, while those that do not match the pattern will be 0.
Postings that were posted on the same (unusual) hour of the day as the current posting.
The rationale of this heuristic is that posting in an unusual time may imply a similar (for example, agitated) state-of-mind.
This requires analysis of usual posting hours, in order to identify unusual times.

Some of the values assigned by this heuristic may be calculated in advance (overnight) while others (e.g., posted on the same hour of the day) need to be calculated on the fly.

### Historical Context Heuristic

The process of re-evaluation of experience, which also involves revisiting journal entries, is a process of reflection that involves relating new information and experiences to previous experiences. However, the ability to form such relations and to view previous events in a wider context depends on new experiences which one has had. Therefore postings for which the user has had more new and related experiences have a better chance of being viewed in a new light, triggering reflection.

This heuristic assigns higher values to postings that share a high similarity with postings that were published at later times. The rationale here is that if a topic was discussed further in future postings, the user is likely to have learned something new on the topic and thus may gain from reflecting on early postings of the same topic. Similarity between postings may be calculated with regular information retrieval methods. Postings will receive higher values the more similar they are to more future postings.

The values assigned by this heuristic need to be updated when new postings are saved, but assuming that the few new postings of one day are not likely to make much of a difference, an overnight calculation is enough.

### Emotional Content (Using Textual Patterns)

Reflecting on feelings and emotions which were or are present is a central process for reflecting on past events. Feelings experienced as negative may need to be processed and resolved. Positive feelings can be celebrated and provide motivation. The expression of feelings indicates strong personal involvement which is likely to bring future interest. Thus, pointing to past postings with emotional content has great potential both for raising interest in the user, and for personal growth in resolving feeling.

This heuristic assigns higher values to postings that contain certain textual expressions that appear in a dictionary that is prepared for this purpose. The goal of this heuristic is to identify postings with emotional content. The dictionary will contain words such as “frustrated”, “hate”, “deadline”; as well as “happy”, “celebration”, or any other emotion. The value assigned by this heuristic will be higher the more words from the dictionary appear in the posting.

The values assigned by this heuristic may be calculated upon publishing of the posting. They need to be recalculated if the configurable dictionary changes.

### Categories

Postings are often categorized according to predefined categories. Some categories may be more suitable for reflection than others. Users may configure the categories they prefer to reflect upon. Other criteria that may use category information may be to give higher probability values to more focused postings (posted to a single rather than multiple categories), or analyzing reflection activities and giving higher values to categories that yielded reflection activity in the past.

### Reflection History

Postings that appeared in the reflection panel in the past will be given lower values by this heuristic than postings that did not appear in the panel. This heuristic aims to make sure that the same postings do not appear in the panel repeatedly.

### Configurability

Different uses may require different configurations for the reflection panel. Participants of a three-month course using a shared resource may find postings from only a month ago useful, but a business manager maintaining resources for career development may benefit from postings which have been posted years ago. The parameters for posting selection may be configurable either by the administrator of the resource, or by individual resource users.

Multiple users of a shared resource may each have different configurations enabling the posting selection for the reflection panel to be individual to a user.

Configuration is done by creating a set of profiles. Each profile sets parameters, such as the weights for each of the heuristics, and settings which affect the calculation of each of the heuristics. Thus a person can have, for example, one profile for longer term reflection about ones progress as a team leader, with an emphasis on selection by history; and a shorter term reflection profile about advancing as a Java programmer, limited to the “Java category” (Java is a trade mark of Sun Microsystems, Inc.). Each time the reflection panel is displayed, one of the profiles from the set of profiles is chosen and used in order to select the post to be displayed.

### User Interface

The reflection panel is displayed in the user interface, as a block of text on the sidebar of the user interface. The reflection panel shows exerts of past postings with enough text for the user to understand the context and have the option to expand the reflection panel to see more (the full past posting). The reflection panel has an input button that will allow the user to trackback and compose a new posting based on the past one.

### EXAMPLES

As discussed in the introduction, there are currently many different systems which could benefit from a reflection panel as described. Such systems include information presentation where one or more users can post a journal entry or other information which is displayed either privately to the individual user or shared by users. Examples, of such systems including information presentation include, but are not limited to the following: Web logs (“blogs”); Web forums in which multiple users contribute to a discussion; Open content web sites allowing user input; Personal electronic journals; Personal workspaces in which daily information is organized; Shared or collaborative workspaces; email messaging; and any other system in which one or more users posts user generated information.

Therefore, the described reflection panel display in a user interface with the associated selection means with heuristic algorithm and user configuration may be provided as part of blog software host systems, personal information management systems, content management systems, workspace collaboration systems, messaging systems, etc.

One embodiment of a reflection panel is provided in the context of a blog. A reflection panel resides on the blog's sidebar and occasionally displays the content of previous postings in one's own blog. Blog users may choose to totally ignore the reflection panel (and even hide it) if it distracts them, but they may find it interesting to click the suggested posting and re-read it. While re-reading, blog users may wish to reflect on the same issue again by clicking on a button on the previous posting for creating a “trackbacking” new posting, a new posting which refers to the old one.

The goal of the reflection panel is to entice reflection unobtrusively, in a way which blends with the normal interaction with the blog environment. The reflection panel attempts to display past postings which have a high potential of evoking a reflective response, thus naturally integrating reflection in the daily activities of the user.

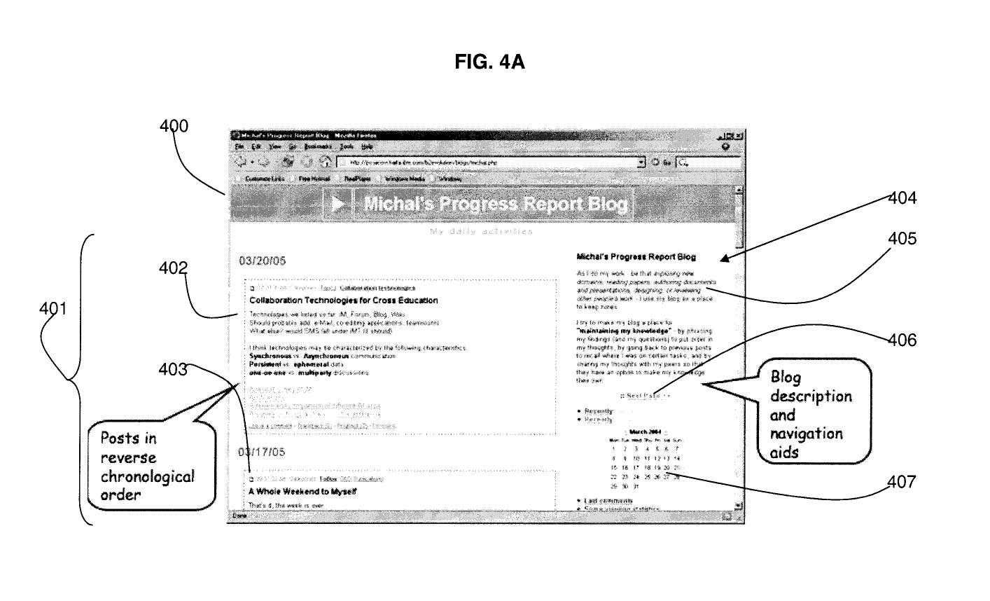

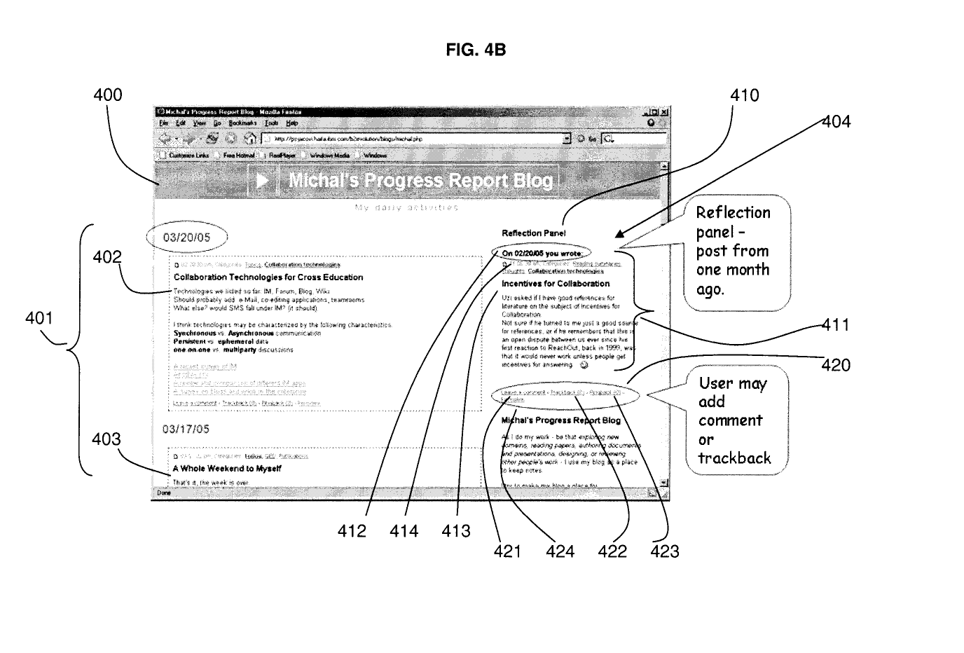

FIGS. 4A and 4B show a user interface in the form of a blog. FIG. 4A shows a typical blog user interface 400 as known in the prior art without a reflection panel. The main area 401 for information postings by the blog owner is shown on the left with a list of postings 402, 403 in reverse chronological order.

A sidebar 404 shown on the right of the user interface 400 has boxes which could be of many types. The example blog shows one box 405 which contains introductory text explaining what the blog is about. Below it there are some navigational aids 406, and below that is a box with a calendar 407.

Referring to FIG. 4B, a reflection panel 410 is provided as an additional box on the sidebar 404. In the example shown, it is displayed at the top of the sidebar 404.

The posting 411 which is displayed in the reflection panel 410 has been originally posted some time in the past, in this case one month ago. Each time the user views a new page (by clicking a link), the refection panel 410 would display a different posting.

In the reflection panel 410, the date 412 and title 413 of the posting 411 are displayed along with links 414 to the categories according to which that posting 411 was posted. If the posting 411 is too long only part of it may be displayed in the reflection panel 410.

Following the text of the posting 411 which is displayed in the reflection panel 410, there are several links 420. These links 420 also appear after every posting in the main area 401 of the blog, but when presented in the reflection panel 410 facilitate reading, commenting and reflecting on the old posting 411.

For example the links 420 may include:
“Leave a comment” 421 which allows the user to add new comments to the old posting 411.
“Trackback” 422 which allows the user to add a new posting which refers to the old posting 411.
“Pingback” 423 which provides notification when somebody links a posting. This enables authors to keep track of who is linking to, or referring to their postings.
“Permalink” 424 which goes to a page which displays the old posting in the main area 401 of the blog, with the text of all comments and trackbacks.

Other embodiments, including web forums in which multiple users contribute to a discussion, open content web sites allowing user input, and shared collaborative workspaces may use a similar user interface to that shown in FIG. 4B in relation to a blog. An additional heuristic may be based on the author of the information postings where a plurality of users can contribute postings.

In systems where the postings are not presented chronologically or reverse chronologically, but instead by topic or by some other ordering, the reflection panel may be prompted to be selected when a different posting is viewed and the heuristics may be based on the subject matter of the viewed posting.

In another embodiment, personal electronic journals and personal workspaces in which daily information is organized, are input to and viewed by only a single user. In such cases, the user interface provides a reflection panel solely for the purposes of prompting reflection by the single user on his own entries.

A system for providing a reflection panel to a resource may be provided as a service to a customer over a network.

The reflection panel automatically stimulates a user with a prompt to reconsider a previous information posting. There is no burden on the user with extra work and he may ignore the reflection panel or consider it at his discretion.

Guided questions which may prompt reflection require construction by an instructor, are specific to a course, and burden the user. The reflection panel does not require an instructor to add questions, and it is unobtrusive.

Search systems are interactive and require the user's awareness that he is in need of further information. The reflection panel is pro-active as it does not require the user's explicit intervention to be triggered.

Remembrance agents aim at assisting the user's current task by providing relevant content from past documents or from any other content corpus. The reflection panel aims at encouraging reflection upon past writings and may only uses the current context as one of its heuristics for selecting the content for reflection. Remembrance agents use the immediate context for selecting relevant material, whereas the reflection panel uses a broader context (e.g., if a user wrote a lot about a certain topic, she may have gained a lot of experience on it and so will be more effective in reflecting upon related past issues).

The invention can take the form of an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for presenting information, comprising:
inputting multiple information postings on a user accessible display, said information postings being generated by one or more users;
updating the user accessible display to show most recently input information postings;
generating a sub-display of a reference to or contents of a previous information posting with a link to the previous information posting;
wherein the sub-display has the purpose of prompting a user to reflect on the previous information posting.

2. A method as claimed in claim 1, wherein generating a sub-display selects a previous information posting using an algorithm based on heuristics applied to previous information postings.

3. A method as claimed in claim 2, wherein the heuristics include temporal, textual, or contextual criteria of the previous postings and assign probabilities to each previous information posting.

4. A method as claimed in claim 2, wherein the heuristics combined for a previous information posting are weighted.

5. A method as claimed in claim 2, wherein the heuristics are configurable to a user's preferences.

6. A method as claimed in claim 2, wherein the heuristics are calculated in advance or calculated on the fly.

7. A method as claimed in claim 2, wherein a different sub-display is generated when a user views a different information posting, after a predetermined time period, or refreshes the display.

8. A method as claimed in claim 1, including creating a new information posting based on or referring to the previous information posting of the sub-display.

9. A method as claimed in claim 1, wherein the sub-display can be hidden by a user.

10. A system for presenting information comprising:
means for inputting multiple information postings on a user accessible display, said information postings being generated by one or more users;
means for updating the user accessible display to show most recently input information postings;
means for generating a sub-display of a reference to or contents of a previous information posting with a link to the previous information posting;
wherein the sub-display has the purpose of prompting a user to reflect on the previous information posting.

11. A system as claimed in claim 10, wherein the means for generating a sub-display selects a previous information posting using an algorithm based on heuristics.

12. A system as claimed in claim 10, wherein the user accessible display displays information postings from a shared resource accessible via a network.

13. A system as claimed in claim 12, wherein the shared resource is a web log, a shared forum, or a web page.

14. A system as claimed in claim 10, wherein the system is a personal information management system, a content management system, a workspace collaboration system, a web log hosting system, or a messaging system.

15. A system as claimed in claim 10, including a graphical user interface including a sidebar for the sub-display including input means to input additional information relating to the previous information posting.

16. A system as claimed in claim 15, wherein the graphical user interface includes an input means to create a new information posting on the user accessible display based on or referring to the previous information posting.

17. A system as claimed in claim 10, wherein the means for generating the sub-display changes the contents of the sub-display when a different part of the information display is selected.

18. A computer program product stored on a computer readable storage medium, comprising computer readable program code means for performing the steps of:
inputting multiple information postings on a user accessible display, said information postings being generated by one or more users;
updating the user accessible display to show most recently input information postings;
generating a sub-display of a reference to or contents of a previous information posting with a link to the previous information posting;
wherein the sub-display has the purpose of prompting a user to reflect on the previous information posting.

19. A method of providing a service to a customer over a network, the service comprising:
generating a sub-display of a reference to or contents of a previous information posting with a link to the previous information posting;
wherein multiple information postings on a user accessible display are generated by one or more users, and wherein the sub-display has the purpose of prompting a user to reflect on the previous information posting.
